(19) United States
(12) Patent Application Publication
(10) Pub. No.: US 2011/0271002 A1
(43) Pub. Date: Nov. 3, 2011

(54) INITIALIZING NETWORK STREAMING OVER MULTIPLE PHYSICAL INTERFACES

(75) Inventors: Martin Martinez, Ladera Ranch, CA (US); Eric Riggert, Lake Forest, CA (US)

(73) Assignee: CANON KABUSHIKI KAISHA, Tokyo (JP)

(21) Appl. No.: 12/772,912

(22) Filed: May 3, 2010

(51) Int. Cl. G06F 15/16

(52) U.S. Cl. 709/231; 709/233

(57) ABSTRACT

The present disclosure is directed to initializing a sending of a single data stream from a sending endpoint to a receiving endpoint. Both of the endpoints each have multiple physical interfaces connecting each endpoint to one or more networks. A first list is sent from a first one of the sending endpoint and the receiving endpoint to a second one of the sending endpoint and the receiving endpoint. The first list includes one or more groups of data communication channels at the first endpoint on which to send or receive data. A selection is then made by the second endpoint of one of the groups of data communication channels included in the first list, by comparing the groups in the first list with groups in a second list. The second list includes groups of data communication channels at the second endpoint on which to send or receive data.

### BACKGROUND

1. Field

The present disclosure generally relates to network streaming, and more specifically relates to initializing network streaming from a sending endpoint to a receiving endpoint.

2. Description of the Related Art

In the field of data streaming over a network, there is a problem in that data streaming from a sending endpoint to a recipient endpoint may be detrimentally affected by a variety of effects such as limited network bandwidth, collisions in data transmission, and latency, which in turn affect the delivery quality of the streamed data. In the future, network bandwidth will invariably increase, which might suggest that this problem will become less significant in the future. In fact, however, recent history has shown that the quantity of data information that needs to be sent over networks grows much faster than the then-current delivery infrastructure, such that it is expected that the problem will persist. As the quantity of data information continues to increase (e.g., High Definition video streaming), an already overburdened system may provide less than adequate data delivery and/or playback quality, or may fail outright.

### SUMMARY

The inventors herein have proposed arrangements that address this problem in a situation where the architecture of the network is such that the sender and the recipient both have multiple physical connections to the network, and/or in situations where there are one or more networks that connect the sender and recipient, and both the sender and recipient each have one or more physical connections to each network. For example, the sender and recipient might be connected over four separate networks including, such as, an Ethernet network, a MoCA (Multimedia over Coax Alliance) network, an Ethernet over powerline network, a HomePNA (Home Phoneline Networking Alliance) network, and/or a wireless network. For each network, both sender and recipient each have one or more physical connections to each network, such as twisted pair cable connecting to the Ethernet network, coaxial cable connecting to the MoCA network, power lines/wires connecting to the Ethernet over powerline network, and one or more radio antennas connecting to the wireless network.

With such an architecture, the single data stream is split into sub-streams and sent over multiple physical interfaces which connect the endpoints of the network, instead of streaming data over only one of the possible physical interfaces. This arrangement is more flexible and resilient to network load or impairments because multiple physical interfaces are used simultaneously.

However, using multiple dissimilar physical interfaces raises a new set of challenges. One of such challenges is that a number of different channels may exist at the sending endpoint which may be used to send data, and a number of different channels may exist at the receiving endpoint which may be used to receive data. In such a structure, data sent over one channel at the sending endpoint might be received by a channel at the receiving endpoint which is dissimilar to the channel at the sending endpoint. As a result, the channel at the receiving endpoint may not be able to handle the data provided by the channel at the sending endpoint, which may negatively affect the efficiency and reliability when sending the data.

In the present disclosure, the foregoing problem is addressed by initializing a sending of a single data stream from a sending endpoint to a receiving endpoint, in which both of the sending endpoint and the receiving endpoint each have multiple physical interfaces connecting the sending endpoint and the receiving endpoint to one or more networks, respectively. A first list is sent from a first endpoint, which is the sending endpoint or the receiving endpoint, to a second endpoint, which is the other of the sending endpoint or the receiving endpoint. The first list includes one or more groups of data communication channels at the first endpoint on which to send or receive data, based at least partially on characteristics of the data communication channels. A selection is then made by the second endpoint of one of the groups of data communication channels included in the first list, by comparing the groups in the first list with groups in a second list. The second list includes one or more groups of data communication channels at the second endpoint on which to receive or send data, based at least partially on characteristics of the data communication channels.

Thus, in an example embodiment described herein, a first list is sent from a first one of the sending endpoint and the receiving endpoint to a second one of the sending endpoint and the receiving endpoint. In one case, the first endpoint is the sending endpoint and the second endpoint is the receiving endpoint. This case is called a push request negotiation. In another case, the first endpoint is the receiving endpoint and the second endpoint is the sending endpoint. This case is called a pull request negotiation. The first list includes one or more groups of data communication channels at the first endpoint on which to send or receive data, based at least partially on characteristics of the data communication channels. A selection is then made by the second endpoint of one of the groups of data communication channels included in the first list. The second endpoint selects the one group of data communication channels by comparing the groups in the first list with groups in a second list. The second list includes one or more groups of data communication channels at the second endpoint on which to send or receive data, based at least partially on characteristics of the data communication channels. The selected group of data communication channels included in the first list is then sent from the second endpoint to the first endpoint. One or more communication channels are then established at the first endpoint and one or more communication channels are established at the second endpoint, respectively. The communication channels are established in accordance with the selected group of data communication channels included in the first list and a corresponding group of data communication channels included in the second list. Data is then sent over the one or more communication channels established at the sending endpoint, and received over the one or more communication channels established at the receiving endpoint.

By virtue of the foregoing arrangement, it is ordinarily possible to intelligently pair communication channels on the sending endpoint with communication channels on the receiving endpoint, so as to efficiently and reliably stream data between the endpoints. More specifically, since a selection is made by a second one of the sending and receiving endpoints of one of groups of data communication channels included in a first list of network channel configurations provided by a first one of the sending and receiving endpoints, it is possible to ensure that data communication channels at the sending endpoint are paired with similar data communication channels at the receiving endpoint. As a result, any negative effects such as a reduction in data throughput, due to, for example, pairing of communication channels at the sending endpoint with incompatible communication channels at the receiving endpoint, can be substantially minimized.

In an example embodiment also described herein, the characteristics of the data communication channels include a medium type of the physical interface associated with the data communication channel. For example, the medium type of the physical interface may be wired or wireless. In addition, the characteristics of the data communication channels include a bandwidth of the physical interface associated with the data communication channel. The characteristics of the data communication channels also include a medium flow control of the physical interface associated with the data communication channel. For example, the medium flow control of the physical interface may be full duplex or half duplex. Further, the characteristics of the data communication channels include a data capacity throughput of the physical interface associated with the data communication channel.

For the characteristic of medium type, a data communication channel associated with a physical interface at the first endpoint having one medium type is paired with a data communication channel associated with a physical interface at the second endpoint having the same medium type. For the characteristic of bandwidth, a data communication channel associated with a physical interface at the first endpoint having one bandwidth is paired with a data communication channel associated with a physical interface at the second endpoint having substantially the same bandwidth. For the characteristic of medium flow control, a data communication channel associated with a physical interface at the first endpoint having one medium flow control is paired with a data communication channel associated with a physical interface at the second endpoint having the same medium flow control. For the characteristic of a data capacity throughput, a data communication channel associated with a physical interface at the first endpoint having one data capacity throughput is paired with a data communication channel associated with a physical interface at the second endpoint having substantially the same data capacity throughput.

In yet another example embodiment described herein, in a case that the second endpoint is not able to select a group of data communication channels from the first list that corresponds with a group of data communication channels from the second list, the second endpoint sends the second list to the first endpoint. The first endpoint then selects a group of data communication channels by comparing the groups of the second list with the groups of the first list, and sends the selected group of data communication channels to the second endpoint.

In an additional example embodiment described herein, in a case that the second endpoint is not able to select a group of data communication channels from the first list that corresponds with a group of data communication channels from the second list, the second endpoint sends a third list including one group of data communication channels to the first endpoint. The first endpoint then selects a group of data communication channels from the first list that conforms to the one group of data communication channels included in the third list.

According to another example embodiment described herein, in a case that a feedback mechanism is to be included to provide feedback information, the selected group of data communication channels at the first endpoint and the corresponding group of data communication channels at the second endpoint, each include one or more communication channels for providing the feedback information from the receiving endpoint to the sending endpoint.

In an additional example embodiment described herein, the groups of data communication channels are registered as bondable virtual interfaces. The bondable virtual interfaces include application requirements, which include at least one of a preferred minimum and maximum bandwidth for the streaming data, a preferred minimum and maximum bandwidth for feedback information, a data stream type category, use restrictions for medium types of physical interfaces, and a preferred number of physical interfaces to be used in sending data. The application requirements are used to determine the characteristics of the data communication channels.

In yet an additional example embodiment described herein, the data stream type category is one of a non-time critical data stream, a near-time critical data stream, and a time critical data stream. An example of a data stream in the time critical (TC) category is an interactive data stream such as a video conference stream. An example of a data stream in the near-time critical (nearTC) category is a stream that carries a High Definition (HD) video content. An example of a data stream in the non-time critical (nonTC) category is a file transfer data stream. The data stream type category is taken into consideration when determining which groups of data communication channels to include in the first list.

According to another example embodiment described herein, the groups of data communication channels included in the first list are provided in order of preference according to the first endpoint. In this regard, the data stream type category can be used to determine the order of preference of the groups of data communication channels according to the first endpoint. As a result, in a case that a number of suitable combinations exist between the groups of data communication channels included in the first list and the groups of data communication channels included in the second list, the stream type category can be used to determine which groups of data communication channels to select.

This brief summary has been provided so that the nature of the disclosure may be understood quickly. A more complete understanding can be obtained by reference to the following detailed description and to the attached drawings.

### BRIEF DESCRIPTION OF DRAWINGS

FIG. 1 is a representative view of a sending endpoint and a receiving endpoint, connected via networks, on which an architecture of an example embodiment may be implemented.

FIG. 2 is a detailed block diagram for explaining the internal architecture of the sending endpoint of FIG. 1.

FIG. 3 is a detailed block diagram for explaining the internal architecture of the receiving endpoint of FIG. 1.

FIG. 4 is a high level view of an architecture according to an example embodiment.

FIG. 5 is another view of a sending endpoint and a receiving endpoint, for providing a general explanation of an example embodiment.

FIG. 6 is a flow chart for providing a detailed explanation of another example embodiment.

### DETAILED DESCRIPTION

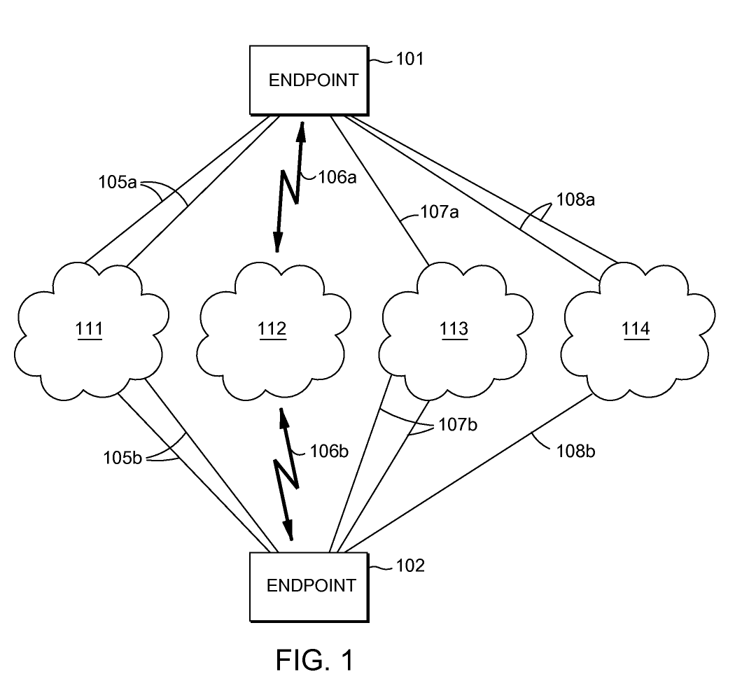

FIG. 1 is a representative view of a sending endpoint and a receiving endpoint, connected via one or more networks, on which an architecture of an example embodiment may be implemented. As shown in FIG. 1, sending endpoint 101 is connected to receiving endpoint 102 through networks 111, 112, 113 and 114. The networks may include similar or dissimilar networks, mixed in any combination, as described below. Sending endpoint 101 includes multiple physical interfaces, including at least one or more physical interface for each different network. As shown in the example of FIG. 1, sending endpoint 101 includes physical interfaces 105a, 106a, 107a and 108a. More specifically, sending endpoint 101 has physical interfaces 105a which connect sending endpoint 101 to network 111. In FIG. 1, sending endpoint 101 is shown to have two physical interfaces 105a connecting to network 111; however, in other embodiments, sending endpoint 101 may have a single physical interface connecting to network 111, or may have more than two physical interfaces connecting to network 111.

Receiving endpoint 102 also has multiple physical interfaces 105b connecting to network 111. Similar to sending endpoint 101, receiving endpoint 102 may also have a single or multiple physical interfaces connecting to network 111. As a result of the physical interface connections, sending endpoint 101 is connected to receiving endpoint 102 through network 111, using physical interfaces 105b. Each of the multiple physical interfaces 105a and 105b to 108a and 108b include one or more data communication channels (not shown).

Similar to the above-described connection between sending endpoint 101 and receiving endpoint 102, sending endpoint 101 and receiving endpoint 102 are connected through networks 112, 113 and 114 via physical interfaces 106a and 106b, 107a and 107b and 108a and 108b. Accordingly, sending endpoint 101 is connected to network 112 through one or more physical interfaces 106a; and, receiving endpoint 102 is connected to network 112 through one or more physical interfaces 106b. Sending endpoint 101 is connected to network 113 through one or more physical interfaces 107a; and, receiving endpoint 102 is connected to network 113 through one or more physical interfaces 107b. Lastly, sending endpoint 101 is connected to network 114 through one or more physical interfaces 108a; and, receiving endpoint 102 is connected to network 114 through one or more physical interfaces 108b. In FIG. 1, sending endpoint 101 and receiving endpoint 102 are shown to be connected through four networks; however, sending endpoint 101 and receiving endpoint 102 may be connected through more or less networks. In this regard, the number of networks is established by a user's demands, or is established by an already existing infrastructure connecting the two endpoints.

Networks 111, 112, 113 and 114 can be many different types of networks, such as, for example, an Ethernet network, a Multimedia over Coax Alliance (MoCA) network, a HomePNA (Home Phoneline Networking Alliance) network, an Ethernet over powerline network (HomePlug), a wireless network, or any other type of network. In addition, the networks connecting the two endpoints can all be a different type of network (e.g., network 111 can be an Ethernet network, while network 112 is a wireless network, network 113 is an Ethernet over powerline network, and network 114 is a MoCA network). On the other hand, the networks connecting the two endpoints can include any variety of combinations of different networks (e.g., network 111 can be a MoCA network, while network 112 is a wireless network, and networks 113 and 114 are Ethernet networks). The type of physical interfaces connecting the endpoints to the networks depends upon the type of network. For example, an endpoint may be connected to an Ethernet network through twisted pair cable, an endpoint may be connected to a MoCA network through coaxial cable, an endpoint may be connected to an Ethernet over powerline network over power lines/wires, and an endpoint may be connected to a wireless network over one or more radio antennas.

The sending endpoint 101 serves as an application sender, which may include, for example, a media server, a conference server, or a storage sender application. A media server is an endpoint that will transfer audio and video data (or other types of large data) to a client. Although the media server is specific to transferring video streams, other types of media servers can be substituted (e.g., an audio-only stream or a large archival stream). The media server may also be a modified third party application accessing the sending endpoint 101. A conference server is an endpoint that sends data (via Unicast or Multicast) to conference players, and is used in providing interactive conference content to participants. A storage sender application is an endpoint that sends data from a device to a receiver, and is used in transferring data between two endpoints (e.g., File Transfer Protocol (FTP)). The storage sender application is primarily used in a PC collaboration as a means to send device data to be stored at an external storage medium.

The receiving endpoint 102 serves as an application receiver, which may include, for example, a media client or media player, a conference player, or a storage receiver application. A media client or media player is an endpoint that receives data from a media server, and is used primarily for video and audio stream playing. A conference player is an endpoint that receives data from the conference server, and is used in playing and interacting within a conference. A storage receiver application is an endpoint that receives data from a storage sender application, and is used in transferring data between two endpoints (e.g., FTP). The storage application receiver is primarily used in a PC collaboration as a means to receive device data to be stored at an external storage medium.

In some instances, a sending endpoint may also simultaneously act as a receiving endpoint. For example, when a sending endpoint serves as a video conferencing application, video would stream from the sending endpoint to the receiving endpoint, and video would stream simultaneously from the receiving endpoint to the sending endpoint. In this example, the sending endpoint would also be acting as a receiving endpoint, and the receiving endpoint would also be acting as a sending endpoint. In other instances, a sending endpoint may become a receiving endpoint after some period of time. For example, a sending endpoint and a receiving endpoint might transfer data back and forth to each other in a ping-pong fashion, rather than simultaneously. In other words, the sending endpoint might complete a transfer of data to the receiving endpoint, and then a second transfer may begin in the opposite direction from the receiving endpoint to the sending endpoint.

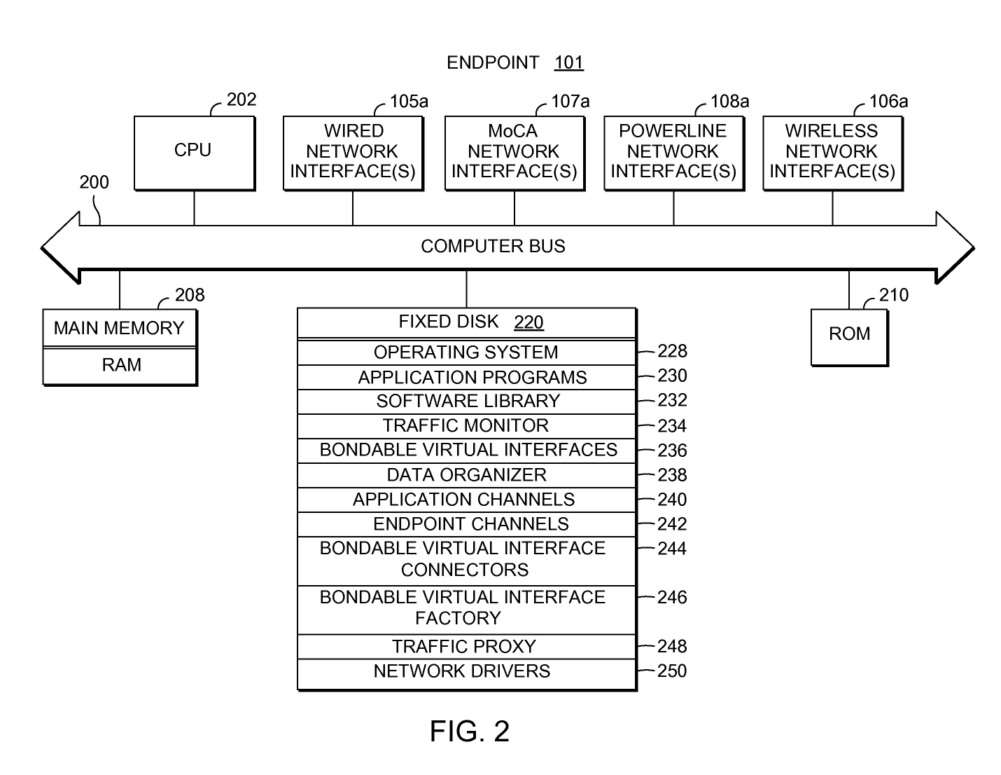

FIG. 2 is a detailed block diagram for explaining the internal architecture of the sending endpoint 101 of FIG. 1. As shown in FIG. 2, sending endpoint 101 includes central processing unit (CPU) 202 which interfaces with computer bus 200. Also interfacing with computer bus 200 are hard (or fixed) disk 220, wired network interface(s) 105a, wireless network interface(s) 106a, MoCA network interface(s) 107a, powerline network interface(s) 108a, random access memory (RAM) 208 for use as a main run-time transient memory, and read only memory (ROM) 210.

RAM 208 interfaces with computer bus 200 so as to provide information stored in RAM 208 to CPU 202 during execution of the instructions in software programs such as an operating system, application programs, and interface drivers. More specifically, CPU 202 first loads computer-executable process steps from fixed disk 220, or another storage device into a region of RAM 208. CPU 202 can then execute the stored process steps from RAM 208 in order to execute the loaded computer-executable process steps. In addition, data such as gathered network performance statistics or other information can be stored in RAM 208, so that the data can be accessed by CPU 202 during the execution of computer-executable software programs, to the extent that such software programs have a need to access and/or modify the data.

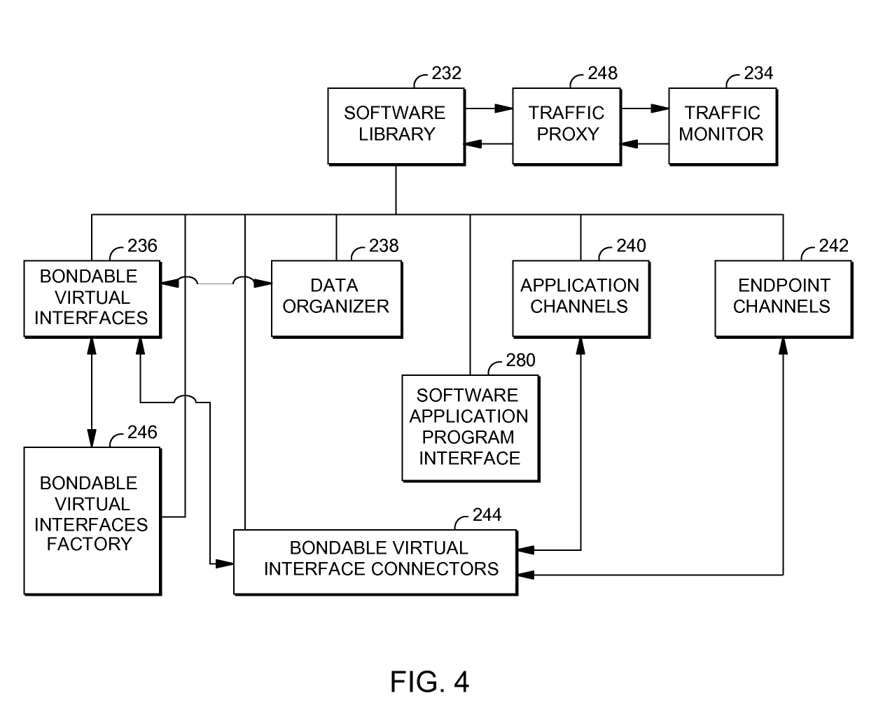

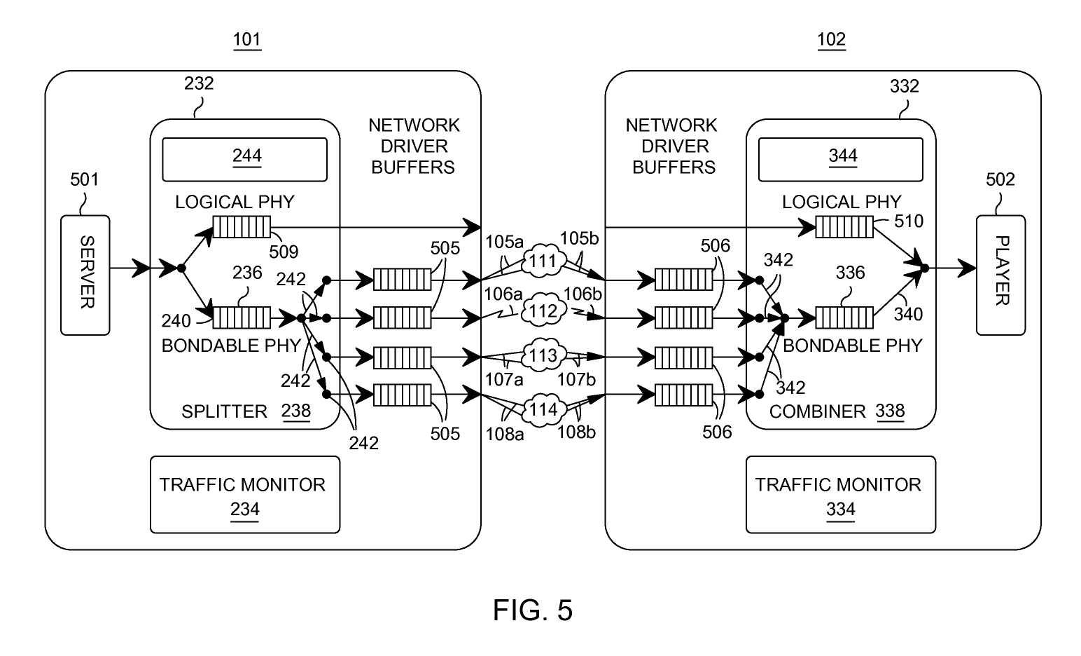

As also shown in FIG. 2, hard disk 220 contains operating system 228, application programs 230 such as programs for starting up and shutting down the sending endpoint 101 or other programs. Hard disk 220 further contains software library 232 for controlling the sending of data from sending endpoint 101. Hard disk 220 also contains traffic monitor 234 for gathering performance statistics for each of the multiple physical interfaces 105a, 106a, 107a and 108a. In addition, hard disk 220 contains bondable virtual interfaces 236, data organizer 238, application channels 240, endpoint channels 242, bondable virtual interface connectors 244, bondable virtual interface factory 246, and traffic proxy 248, each of which is instantiated by the software library 232 and will be described in more detail below with reference to FIGS. 4 and 5. Traffic proxy 248 may be used as a communication interface between the software library 232 and the traffic monitor 234. Lastly, hard disk 220 contains network drivers 250 for software interface to networks such as networks 111, 112, 113 and 114.

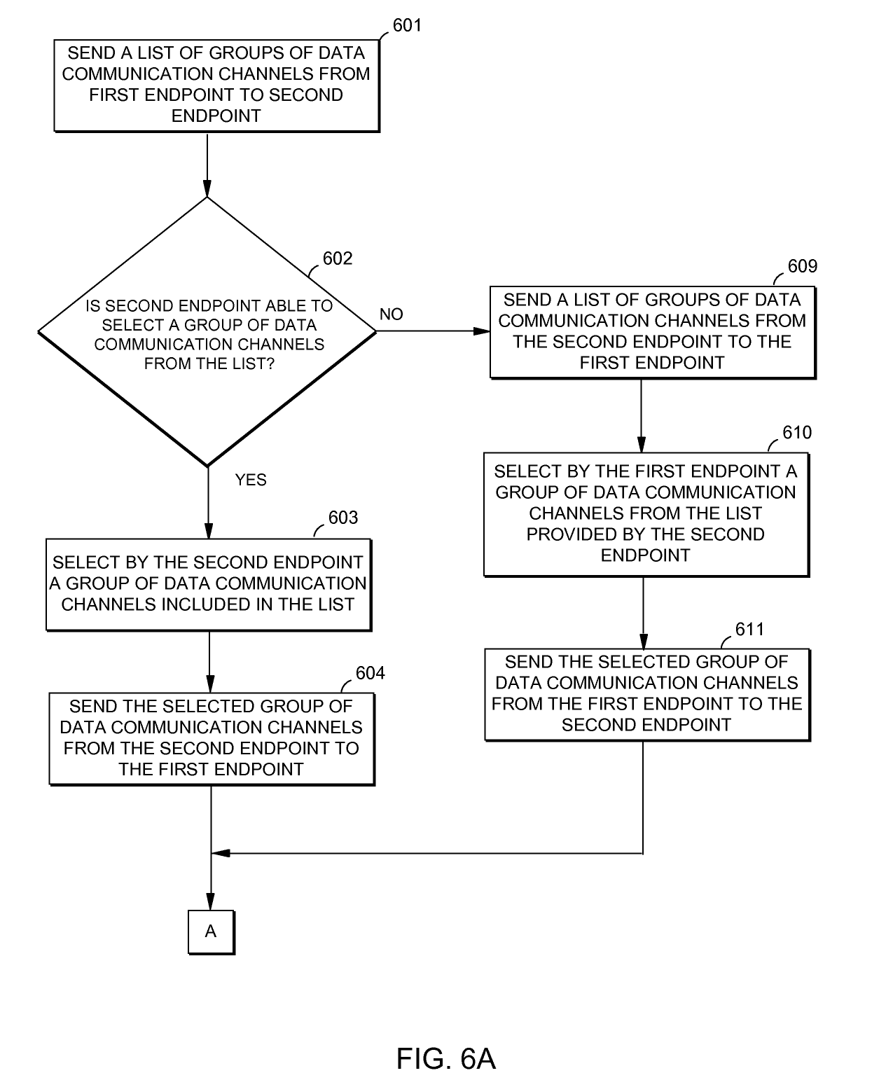

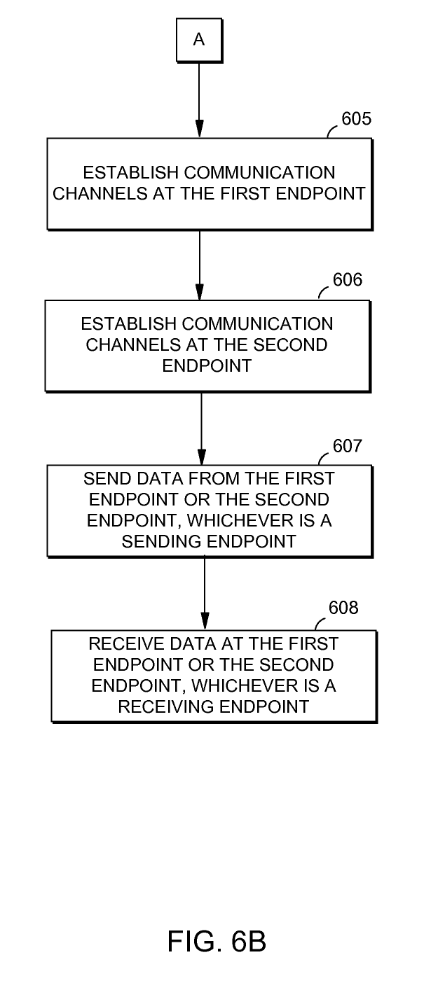

In an example embodiment, software library 232 and traffic monitor 234 are loaded by CPU 202 into a region of RAM 208. CPU 202 then executes the stored software library 232 and the traffic monitor 234 from RAM 208 in order to execute the loaded computer-executable steps. In addition, application programs 230 are loaded by CPU 202 into a region of RAM 208. CPU 202 then executes the stored process steps as described in detail below in connection with FIG. 6, in order to execute the loaded computer-executable steps.

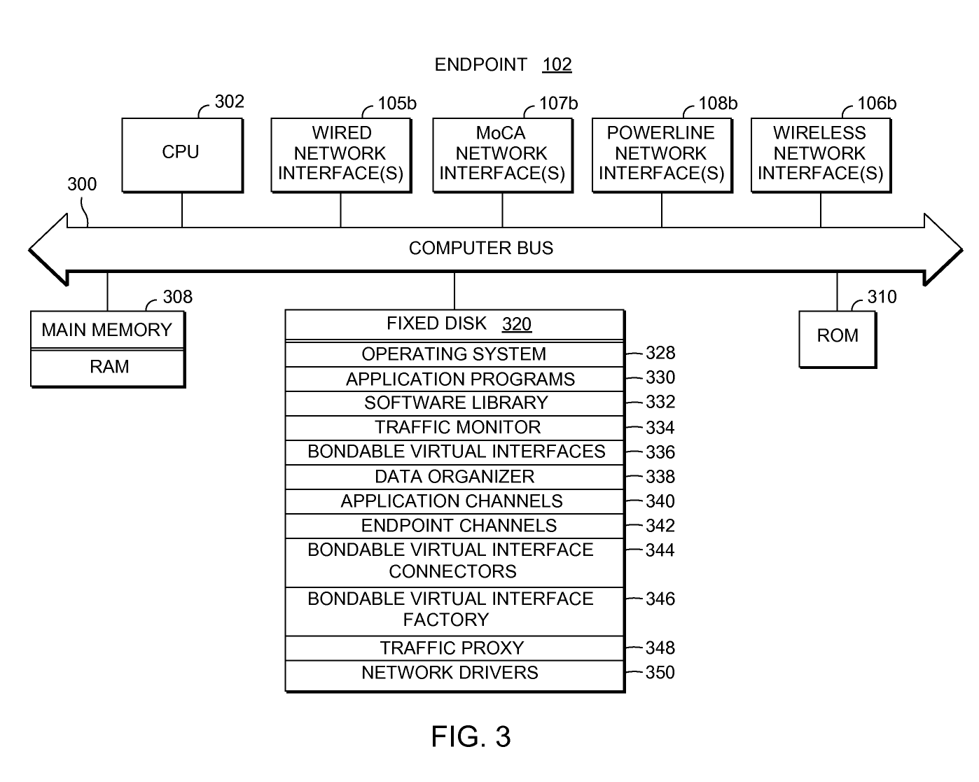

FIG. 3 is a detailed block diagram for explaining the internal architecture of the receiving endpoint 102 of FIG. 1. As shown in FIG. 3, receiving endpoint 102 includes central processing unit (CPU) 302 which interfaces with computer bus 300. Also interfacing with computer bus 300 are hard (or fixed) disk 320, wired network interface(s) 105b, wireless network interface(s) 106b, MoCA network interface(s) 107b, powerline network interface(s) 108b, random access memory (RAM) 308 for use as a main run-time transient memory, and read only memory (ROM) 310.

RAM 308 interfaces with computer bus 300 so as to provide information stored in RAM 308 to CPU 302 during execution of the instructions in software programs such as an operating system, application programs, and interface drivers. More specifically, CPU 302 first loads computer-executable process steps from fixed disk 320, or another storage device into a region of RAM 308. CPU 302 can then execute the stored process steps from RAM 308 in order to execute the loaded computer-executable process steps. In addition, data such as gathered network performance statistics or other information can be stored in RAM 308, so that the data can be accessed by CPU 302 during the execution of computer-executable software programs, to the extent that such software programs have a need to access and/or modify the data.

As also shown in FIG. 3, hard disk 320 contains operating system 328, application programs 330 such as programs for starting up and shutting down the receiving endpoint 102 or other programs. Hard disk 320 further contains software library 332 for controlling the receiving of data from receiving endpoint 102.

Software library 332 in this example is identical to software library 232 in sending endpoint 101. However, in other embodiments, the software library 332 need not be identical to library 232, so long as the two libraries implement a similar software architecture relative to the software library, the traffic monitor, the bondable virtual interfaces, and the data organizer. For example, the sending and receiving endpoints might implement different versions of the same software architecture. Or the sending and receiving endpoints might implement architecture that target different operating systems, such as Windows on the sending endpoint and Linux on the receiving endpoint. Or, the sending endpoint and the receiving endpoint might implement architecture that is OS-neutral like JAVA. Hard disk 320 also contains traffic monitor 334 for gathering performance statistics for each of the multiple physical interfaces 105b, 106b, 107b and 108b. In addition, hard disk 320 contains bondable virtual interfaces 336, data organizer 338, application channels 340, endpoint channels 342, bondable virtual interface connectors 344, bondable virtual interface factory 346, and traffic proxy 348, each of which is instantiated by the software library 332 and will be described in more detail below with reference to FIGS. 4 and 5. Traffic proxy 348 may be used as a communication interface between the software library 332 and the traffic monitor 334. Lastly, hard disk 320 contains network drivers 350 for software interface to networks such as networks 111, 112, 113 and 114.

In an example embodiment, software library 332 and traffic monitor 334 are loaded by CPU 302 into a region of RAM 308. CPU 302 then executes the stored process steps of the software library 332 and the traffic monitor 334 from RAM 308 in order to execute the loaded computer-executable steps. In addition, the process steps of the application programs 330 are loaded by CPU 302 into a region of RAM 308. CPU 302 then executes the stored process steps as described in detail below in connection with FIG. 6, in order to execute the loaded computer-executable steps.

### General Description of Architecture

Transferring data between two endpoints in an efficient manner is difficult. Efficiency can be improved in general by increasing the amount of information concerning the nature of the transfer. For example, efficiency can be improved with an understanding of how to send data between two endpoints and also an understanding of the type of data being sent. Further, by identifying multiple physical interfaces and combining them together into one physical interface (i.e., bondable virtual interface), data throughput may be improved.

In a simplistic architecture, a media receiver/player requests (via e.g., HTTP or RTSP) for a movie stream from a media server. The media server then sends data to the client with some, but probably little concern as to the means or how well the client may have received the media stream data. In contrast, within the architecture of this example embodiment, the media client provides profile information (i.e., a suggested or predetermined bondable virtual interface configuration) as to the type of the media to be streamed, and negotiates with the media server as to the physical interfaces available to exchange data, which will be described in more detail below in connection with FIG. 7. With this knowledge of media type, both the sending and receiving buffer can be modified to improve throughput. In a case where there are multiple logical physical interfaces, the creation of a combined (or bondable virtual interface) physical interface will occur. In this regard, a bondable virtual interface is a combination of physical interfaces that can send data via multiple physical interfaces. Further, feedback information will be sent between both endpoints to improve throughput. The media client then receives the segments on the multiple physical interfaces, recombines the segments and provides the data to the media client's player (whether included in the media client or connected to the media client). Using this architecture makes it possible to ordinarily improve throughput by: (1) Sending information back (via a feedback channel) to the endpoint regarding changes to the data stream or processing of the data, which improves the efficiency of buffer management, and (2) using a bondable virtual interface which increases throughput of data by using multiple physical interfaces to send the data.

FIG. 4 is a high level view of an architecture according to an example embodiment. As shown in FIG. 4, the architecture includes software library 232 and traffic monitor 234. The software library 232 is connected to and communicates with the traffic monitor 234 through traffic proxy 248. In this regard, the software library 232 instantiates and associates with the traffic monitor 234 via the traffic proxy 248. However, the traffic proxy 248 may be omitted, and the software library 232 and the traffic monitor 234 may communicate with each other directly.

As used herein, the word “instantiate” refers to the construction in memory of a software object, such as by use of an object factory. How the software object is created varies among different programming languages. In prototype-based languages, an object can be created from nothing, or an object can be based on an existing object. In class-based language, objects are derived from classes, which can be thought of as blueprints for constructing the software objects.

As further shown in FIG. 4, the software library 232 is connected to bondable virtual interfaces 236, bondable virtual interface factory 246, data organizer 238, software application program interface 280, application channels 240, and endpoint channels 242. In this regard, the software library 232 instantiates and associates with the bondable virtual interfaces 236, the bondable virtual interface factory 246, the data organizer 238, the software application program interface 280, the application channels 240, and the endpoint channels 242. In addition, the data organizer 238 instantiates a data splitter or a data combiner (both of which are described below in detail in connection with FIG. 5), depending on whether the architecture is implemented on a sending endpoint or a receiving endpoint. The foregoing mentioned components will be described, including their use and functionality, in more detail below in connection with FIG. 5.

Furthermore, the bondable virtual interface factory 246 is connected to and associates with the bondable virtual interfaces 236. The bondable virtual interfaces 236 are also connected to and associate with the data organizer 238 and the bondable virtual interface connectors 244. The bondable virtual interface connectors 244 also associate with application channels 240 and endpoint channels 242.

The above-mentioned architecture will now be described in more detail in connection with FIG. 5. FIG. 5 is another view of the sending endpoint 101 and the receiving endpoint 102 shown in FIG. 1, for providing an explanation of an example embodiment of the architecture included in both endpoints. As discussed above in connection with FIG. 1, the architecture is for streaming data from a sending endpoint 101 to a receiving endpoint 102 which are connected to each other by one or more networks (111, 112, 113, 114 of FIG. 1). Each of the sending endpoint 101 and the receiving endpoint 102 has multiple physical interfaces (105a and b, 106a and b, 107a and b and 108a and b of FIG. 1), each for interfacing to a respective one of the one or more networks. The architecture for controlling the streaming of the data is implemented on both the sending endpoint 101 and the receiving endpoint 102.

As shown in FIG. 5, the architecture on the sending endpoint 101 includes a software library 232 and a traffic monitor 234. The traffic monitor 234 is for gathering performance characteristics of each of the multiple physical interfaces. More specifically, the traffic monitor 234 is an operating system-specific application or (daemon) service that provides the software library 232 with all of the available physical interfaces, and with individual physical interface performance/traffic statistics and data. The traffic monitor 234 may obtain network status by periodically making system calls to system's data structures to acquire statistics for each physical interface of the sending endpoint 101. This data is then used by the traffic monitor 234 to specify corresponding configurations for bondable virtual interfaces, which will be described in more detail below in connection with FIG. 6, including a list of suitable known bondable virtual interfaces that can be used to transfer data based on current network traffic. The traffic monitor 234 communicates information back and forth between the software library 232. As shown in FIG. 5, the traffic monitor 234 communicates directly with the software library 232; however, in other embodiments, the traffic monitor 234 can communicate with the software library 232 via traffic proxy 248 as described above in connection with FIG. 4.

The software library 232 is for controlling the sending of the data stream from the sending endpoint 101. In controlling the sending of data, the software library 232 instantiates a plurality of bondable virtual interfaces 236 and a data organizer 238. In addition, the software library 232 instantiates logical physical interfaces 509. The logical physical interface 509 is an abstraction of a physical interface, which has a uniform interface. In addition, the bondable virtual interfaces 236 are instantiated by the software library based on the information communicated by the traffic monitor 234, for splitting the data stream into multiple data substreams at the sending endpoint 101. A bondable virtual interface is a clustering of two or more logical physical interfaces as a bondable object that aggregates available bandwidth with a single thread to manage a common buffer memory. The bondable virtual interface has a second thread to listen to a single feedback path from the receiving endpoint 102, and has additional threads for managing data transfer from a common buffer memory to each of an associated logical physical interface. An example of a bondable virtual interface is a pair of 802.11g wireless interfaces combined for a nominal available bandwidth of 44 Mb/s, assuming ˜22 Mb/s of effective bandwidth for each individual interface.

In addition, the data organizer is used for designating one of the plurality of bondable virtual interfaces 236 for splitting the data stream. At the sending endpoint 101, the data organizer 238 instantiates a data splitter 238 for implementing the designated one of the plurality of bondable virtual interfaces 236 at the sending endpoint 101. In this regard, the data organizer 238 is a parent object for the data splitter, and includes functionality for the registration of new or added bondable virtual interfaces. Moreover, the data organizer 238 is inherited by the data splitter 238. The data splitter 238 contains the bondable virtual interfaces 236 class implementation, and contains the associated behavior for splitting the input data stream onto the multiple physical interfaces.

Similar to the sending endpoint 101, in the receiving endpoint 102, the architecture includes a software library 332 and a traffic monitor 334. The traffic monitor 334 is for gathering performance characteristics of each of the multiple physical interfaces. More specifically, the traffic monitor 334 is an operating system-specific application or (daemon) service that provides the software library 332 with all of the available physical interfaces and with individual physical interface performance/traffic statistics and data. The traffic monitor 334 may obtain network status by periodically making system calls to system's data structures to acquire statistics for each physical interface of the receiving endpoint 102. This data is then used by the traffic monitor 334 to specify corresponding configurations for bondable virtual interfaces, which will be described in more detail below in connection with FIG. 6, including a list of suitable groups of data communication channels that can be used to transfer data based on current network traffic. The traffic monitor 334 communicates information back and forth between the software library 332. In FIG. 5, the traffic monitor 334 communicates directly with the software library 332; however, in other embodiments, the traffic monitor 334 can communicate with the software library 332 via a traffic proxy as described above in connection with FIG. 4.

The software library 332 is for controlling the receiving of the data stream at the receiving endpoint 102. In controlling the receiving of data, the software library 332 instantiates a plurality of bondable virtual interfaces 336 and a data organizer 338. In addition, the software library 332 instantiates logical physical interfaces 510. The logical physical interfaces 510 are substantially the same as logical physical interfaces 509, and provide the same functions. The bondable virtual interfaces 336 are instantiated by the software library based on the information communicated by the traffic monitor 334, for combining the multiple data sub-streams into the data stream at the receiving endpoint 102. In addition, the data organizer is for designating one of the plurality of bondable virtual interfaces 236 for combining the data stream.

At the receiving endpoint 102, the data organizer 338 instantiates a data combiner 338 for implementing the designated one of the plurality of bondable virtual interfaces 336 at the receiving endpoint 102. In this regard, the data combiner 338 is a parent object for the data combiner 338, and includes functionality for the registration of new or added bondable virtual interfaces. Moreover, the data organizer 338 is inherited by the data combiner 338. The data combiner 338 contains the bondable virtual interfaces 336 class implementation, and contains the associated behavior for combining multiple input streams into a resulting single data stream.

At startup of the architecture, the data splitter 238 and the data combiner 338 read network statistics provided by the traffic monitor 234 and 334. The traffic monitors' network statistics are updated periodically (at optionally application specified intervals), and are organized to display an ordered list of recommended bondable physical interface configurations, along with a minimum bandwidth available for each, which will be described in more detail below in connection with FIG. 6.

As further shown in FIG. 5, the sending endpoint 101 and the receiving endpoint 102 are each connected to one or more applications, such as application server 501 and application player 502, respectively. In this regard, the software library 232 of the sending endpoint 101 and the software library 332 of the receiving endpoint 102 further instantiate one or more application channels 240 and 340, respectively, connecting the software libraries 232 and 332 to one or more applications 501 and 502, respectively. The one or more application channels 240 write data to the software library 232, the written data having been received by the sending endpoint 101 from the one or more applications 501. In addition, the one or more application channels 340 read data from the software library 332, the read data having been sent from the receiving endpoint 102 to the one or more applications 502 connected to the receiving endpoint 102. For the application channels, a “named-socket” can be used, which provides a very similar interface to the traditional “single socket” approach in common usage. Moreover, the one or more application channels 240 and 340 include an event handling mechanism to indicate when there is data to be read from or written to the software libraries 232 and 332. The event handling mechanism for a named-socket is a select; however, many other means can be used for triggering events on the application channels.

As shown in FIG. 5, the software libraries 232 and 332 further instantiate multiple endpoint channels 242 and 342, respectively, connecting the software libraries 232 and 332 to the multiple physical interfaces 105a to 108a and 105b to 108b through network driver buffers 505 and 506. The multiple endpoint channels 242 and 342 write data to the software library 332, the written data having been received at the receiving endpoint 102 from the sending endpoint 101, and read data from the software library 232, the read data having been sent from the sending endpoint 101 to the receiving endpoint 102. The multiple endpoint channels 242 and 342 include an event handling mechanism to indicate when there is data to be read from or written to the multiple physical interfaces 105a and 105b to 108a and 108b. In addition, the network driver buffers 505 and 506 are provided to store data before sending data on the sending side, and before reconstructing the data stream and providing the single data stream to the application player 502 on the receiving side. In general, for the multiple endpoint channels, UDP and/or TCP sockets are used to write and read data to/from a network. Moreover, the event handling mechanism for the endpoint channels can be a select; however, other means for triggering events on the endpoint channels may be used. Lastly, an endpoint channel usually has an associated physical interface (e.g., an Ethernet socket); however, other instances exist in which this is not the case. For example, the case exists of using one physical interface but using multiple ports (e.g., using 2 sockets using IP address 192.168.10.1 port 10000 and port 10001).

The bondable virtual interfaces 236 and 336, as shown in FIG. 5, are created by the data splitter 238 or the data combiner 338 to perform the splitting or combining of the data stream. The bondable virtual interfaces 236 and 336 conform to an interface, which allows them to be used generically in the framework. In other words, one bondable virtual interface could be substituted with another bondable virtual interface quite easily without changing any interface requirements elsewhere in the software library, or in an application. Lastly, a bondable virtual interface can have multiple physical interfaces associated with it, or a bondable virtual interface can have a single logical physical interface (as is the case with sockets using one physical interface but with multiple ports).

In addition, the bondable virtual interfaces 236 and 336 have the basic functionality to split or combine data (based upon the role provided by the data splitter 238 or the data combiner 338). In general, the bondable virtual interfaces may be a reduction of a number or a set of rules regarding how to handle data from one or more application channels split over one or more endpoint channels (or vice versa, when recombining data). Thus, different types of bondable virtual interfaces may be created. Three examples of such bondable virtual interfaces are: a simple TCP Bondable virtual interface, a simple UDP bondable virtual interface, and a feedback TCP bondable virtual interface. A simple TCP bondable virtual interface is a bondable virtual interface consisting of multiple physical network interfaces, sending data with each interface using standard TCP connections. An example of a simple TCP bondable virtual interface would be a “round robin” type bondable virtual interface, which uses multiple interfaces to send data.

A simple UDP bondable virtual interface is a bondable virtual interface consisting of multiple physical network interfaces, and sending data with each interface using standard UDP datagrams.

A feedback TCP bondable virtual interface is a bondable virtual interface which utilizes feedback from the receiving endpoint to change the manner in which data is sent over multiple physical network interfaces using TCP connections.

Furthermore, the software libraries 232 and 332 further instantiate a plurality of bondable virtual interface connectors 244 and 344, respectively. Each bondable virtual interface connector is associated with a specific bondable virtual interface. The bondable virtual interface connectors 244 and 344 ensure that the connections between the software libraries 232 and 332 and the multiple physical interfaces 105a to 108a and 105b to 108b via the multiple endpoint channels 242 and 342, respectively, are ready to accept data before sending data from the sending endpoint 101 to the receiving endpoint 102. In addition, the bondable virtual interface connectors 244 and 344 ensure that the connections between the software libraries 232 and 332 and the one or more applications 501 and 502 via the one or more application channels 240 and 340, respectively, are ready to accept data before sending data from the sending endpoint 101 to the receiving endpoint 102.

When sending streaming data from the sending endpoint 101 to the receiving endpoint 102, the one or more applications 501 specify a category of time objective: the categories include a non-time critical objective, a time critical objective, or a near-time critical objective. A non-time critical data stream is a data stream where the data should be received without error; however, time may not be a critical factor (i.e., there may be scenarios (or situations) where time is a critical factor). In these scenarios, a contributing factor for a non-time critical data stream should also include data integrity and thus, in these situations, there is a significant difference between non-time critical, near-time critical and time critical. For example, a non-time critical objective would be specified for a simple file transfer, because the data in this scenario ordinarily should be received without error, and arrival time may not be important for this data.

A near-time critical data stream is a data stream where the data is bound to an endpoint within a range of time. For example, a video stream can possibly be buffered for 5 seconds before the first video frame is displayed on the screen. Or, in the case of a larger memory buffer or hard drive, the first couple of minutes can be burst from the sender to the receiver (i.e., video server to video player). Thus, after the head start (buffer or system priming) has been buffered, the remaining data can be sent in a more leisurely manner, as long as it is received in time to be consumed by the player without interruption in playback. Further, in video streams, it is often the case that some of the packets may be dropped, corrupted or lost due to collision or other network impairments. In this regard, UDP is often the de-facto standard of video streaming and UDP does not guarantee delivery.

For a time-critical data stream, it is usually imperative that the information be received as quickly as possible. Moreover, a time critical objective would be specified when streaming an interactive video stream such as a video conference, because the data in this scenario should be received as soon as possible, while a loss of an insignificant portion of the data may be acceptable.

For the near-time critical and the time critical data streams, transferring of the stream will involve a payload stream mechanism, a feedback stream mechanism, and a control stream mechanism. The payload stream mechanism sends the payload content from the sending endpoint 101 to the receiving endpoint 102. In the architecture, the payload stream is sent via a bondable virtual interface, for example, using an RTP-like protocol where multiple physical interfaces will be used to send data to the receiving endpoint 102. The feedback stream mechanism sends processing and physical interface behavior information between the receiving endpoint 102 and the sending endpoint 101 (or in other scenarios vice-a-versa) using, for example, an RTCP like protocol. The control stream mechanism sends content control commands from the receiving endpoint 102 to the sending endpoint 101 (e.g., play, pause, etc.) using, for example, an RTSP like protocol.

For a non-time critical data stream, the transferring of the stream within the architecture will have the same behavior as the near-time and the time critical data streams with no control stream. Thus, the transferring of the stream for a non-time critical data stream involves a payload stream mechanism and a feedback stream mechanism, each having similar characteristics as the stream mechanisms of the near-time and the time critical data streams.

Furthermore, the software libraries 232 and 332 each further comprise a software application program interface 280, as described in connection with FIG. 4, which consists of a set of commands used by the one or more applications 501 and 502 to utilize the architecture. In addition, the software libraries 232 and 332 each instantiate a bondable virtual interface factory 246, as described in connection with FIG. 4, for registering the newly created ones of the plurality of bondable virtual interfaces, unregistering ones of the plurality of bondable virtual interfaces which are no longer available, and providing a list of available bondable virtual interfaces to the data organizer.

As discussed above, the traffic monitors 234 and 334 may communicate with the software libraries 232 and 332, respectively, via a traffic proxy. In this case, the software libraries 234 and 334 each further instantiate a traffic proxy 248 (as described in connection with FIGS. 2 and 4) and a traffic proxy 348 (as described in connection with FIG. 3) for communicating information between the traffic monitors 234 and 334 and the software libraries 232 and 332, respectively, via a shared common interface. The common interface is a shared library, which contains objects containing information and the means to share this common data between the traffic monitors 232 and 332 and the traffic proxies 248 and 348. The transport mechanism can be changed easily and additional information can be added (e.g., by adding new objects). Furthermore, in cases where the bondable virtual interface uses some form of feedback mechanism, traffic problems identified by feedback will be relayed to the traffic monitors 234 and 334 via the traffic proxies 248 and 348.

In general, all interaction between the architecture and other applications is conducted through a basic interface. This basic interface is comprised of a core functionality, which is specific to the architecture, and behavioral functionality, which is specific to the operation of the interfacing application. Examples of core functionality would be a startup and shutdown of the architecture. Behavioral functionality examples might include RTSP, or URL connection functionality. For example, the architecture will provide a setup functionality to extend the standard RTSP setup functionality, in which the extension to RTSP is obtainable from an RTSP OPTIONS command. In another example, URL connection functionality can be added to achieve file transfer behavior.

Generally, the traffic monitors obtain information about all of the physical interfaces connected to the sending endpoint 101 and the receiving endpoint 102, regardless of whether the physical interface is associated with a bondable virtual interface. In obtaining the information, the traffic monitors gather information, via for example some OS means, regarding a state of the physical interfaces, as well as the state of data communication channels within the physical interfaces. The traffic proxies obtain information regarding the physical interfaces via the traffic monitors and passes the information to interested bondable virtual interfaces. This may be performed using at least the following two methods. First, at the creation of the bondable virtual interface, the bondable virtual interface registers all participating physical interfaces with the traffic proxy, thus signifying that any relevant information pertaining to the registered physical interfaces should be passed from the traffic monitor to the bondable virtual interface. However, there is a possibility due to physical hardware constraints that the bondable virtual interface can not be registered, and the registration of the bondable virtual interface might fail. Second, any information pertaining to any of the physical interfaces should be sent from the traffic monitor to any virtual bondable virtual interface (via the traffic proxy), and the responsibility of extracting relevant information falls upon either the traffic proxy and/or existing bondable virtual interfaces. In the case of the traffic proxy, information about where to send particular information regarding a particular physical interface, which would require registration association between the bondable virtual interface and the physical interface.

The bondable virtual interface can also provide information about specific data communication channels within the bondable virtual interface and send a message (e.g., an alert or other means stating there may be an issue with the channel) to the traffic monitor via the traffic proxy signifying a possible issue on this channel. This implies that there is an association between channels and physical interfaces that can be stored in the bondable virtual interface or traffic proxy.

In the above description with respect to FIGS. 2 to 5, use of the software library can lead to certain efficiencies and programming conveniences, but its use is not mandatory and other libraries can be used, or no library at all, so long as the features of the claims are achieved. A more detailed discussion of the software library can be found in U.S. application Ser. No. 12/463,366, filed May 8, 2009, titled “Efficient Network Utilization Using Multiple Physical Interfaces”, by Martin Martinez, et al., the content of which is incorporated by reference herein.

### Initializing Network Streaming Over Multiple Physical Interfaces

FIG. 6 is a flowchart for providing a detailed explanation of another example embodiment. More specifically, FIG. 6 depicts a flowchart for providing a detailed explanation of an example embodiment for initializing a sending of a single data stream from a sending endpoint 101 to a receiving endpoint 102 as shown in FIG. 1. Both of the sending endpoint 101 and the receiving endpoint 102 each have multiple physical interfaces (105a and 105b to 108a and 108b of FIG. 1) connecting the sending endpoint 101 and the receiving endpoint 102 to one or more networks 111 to 114 of FIG. 1, respectively. In this example embodiment, the data stream is split and sent over the multiple physical interfaces, such as multiple physical interfaces 105a and 105b to 108a and 108b.

As shown in FIG. 6, in step 601, a first list is sent from a first one of the sending endpoint 101 and the receiving endpoint 102 to a second one of the sending endpoint 101 and the receiving endpoint 102. In one case, the first endpoint is the sending endpoint 101 and the second endpoint is the receiving endpoint 102. This case is called a push request negotiation. In a push request negotiation, a client will connect to a server via a well defined Port or Service (e.g., a web service). Since this is a well known port or service, it may be associated with an application to perform some task. This application may have a registered bondable virtual interface which is provided to the traffic monitor.

In another case, the first endpoint is the receiving endpoint 102 and the second endpoint is the sending endpoint 101. This case is called a pull request negotiation. In a pull request negotiation, the client will provide the first list of groups of data communication channels. Again, since this is a well known port or service, it may be associated with an application to perform some task, and this application may have a registered bondable virtual interface which is provided to the server's traffic monitor.

In step 601, the first list includes one or more groups of data communication channels at the first endpoint on which to send or receive data, based at least partially on characteristics of the data communication channels. For example, the list may include two groups of data communication channels. The first group of data communication channels may include one data communication channel included in physical interface 105a, a second data communication channel included in physical interface 106a, and a third data communication channel included in physical interface 107a. The second group of data communication channels may include two data communication channels included in physical interface 107a, and a data communication channel included in physical interface 108a.

The characteristics of the data communication channels include a medium type of the physical interface associated with the data communication channel. For example, the medium type of the physical interface may be wired or wireless. For the characteristic of medium type, a data communication channel associated with a physical interface at the first endpoint having one medium type is paired with a data communication channel associated with a physical interface at the second endpoint having the same medium type. Accordingly, a data communication channel associated with a wireless physical interface connected to the first endpoint, for example, physical interface 106a, should be paired with a data communication channel associated with a wireless physical interface connected to the second endpoint, for example, physical interface 106b.

In addition, the characteristics of the data communication channels include a bandwidth of the physical interface associated with the data communication channel. Bandwidth refers to a maximum data throughput. For the characteristic of bandwidth, a data communication channel associated with a physical interface at the first endpoint having one bandwidth is paired with a data communication channel associated with a physical interface at the second endpoint having substantially the same bandwidth. Accordingly, a data communication channel associated with a physical interface connected the first endpoint having a bandwidth of 10 Gb/s should be paired with a data communication channel associated with a physical interface connected to the second endpoint having a bandwidth substantially close to 10 Gb/s.

The characteristics of the data communication channels also include a medium flow control of the physical interface associated with the data communication channel. For example, the medium flow control of the physical interface may be full duplex or half duplex. For the characteristic of medium flow control, a data communication channel associated with a physical interface at the first endpoint having one medium flow control is paired with a data communication channel associated with a physical interface at the second endpoint having the same medium flow control. Accordingly, a data communication channel associated with a physical interface connected to the first endpoint having a half duplex medium flow control, such as CSMA/CD (Carrier Sense Multiple Access/Collision Detect), should be paired with a data communication channel associated with a physical interface connected to the second endpoint having a half duplex medium flow control. In addition, a data communication channel associated with a physical interface connected to the first endpoint having a full duplex medium flow control should be paired with a data communication channel associated with a physical interface connected to the second endpoint having a half duplex medium flow control.

Further, the characteristics of the data communication channels include a data capacity throughput of the physical interface associated with the data communication channel. Data capacity throughput is the maximum bandwidth minus a current usage of bandwidth. For the characteristic of a data capacity throughput, a data communication channel associated with a physical interface at the first endpoint having one data capacity throughput is paired with a data communication channel associated with a physical interface at the second endpoint having substantially the same data capacity throughput. Accordingly, a data communication channel associated with a physical interface connected to the first endpoint having a data capacity throughput of 100 Mb/s should be paired with a data communication channel associated with a physical interface connected to the second endpoint having a data capacity throughput substantially close to 100 Mb/s.

The groups of data communication channels are registered as bondable virtual interfaces. The bondable virtual interfaces include application requirements, which include at least one of a preferred minimum and maximum bandwidth for the streaming data, a preferred minimum and maximum bandwidth for feedback information, a data stream type category, use restrictions for medium types of physical interfaces, and a preferred number of physical interfaces to be used in sending data. The application requirements are used to determine the characteristics of the data communication channels described above.

In an example, the application requirements may include a preferred minimum bandwidth of 10 Mb/s and a maximum bandwidth of 100 Mb/s for streaming data. In this example, the groups of data communication channels should have the characteristic of a bandwidth that falls between 10 Mb/s and 100 Mb/s. Similarly, if the application requirements include a preferred minimum bandwidth of 10 Mb/s and a maximum bandwidth of 100 Mb/s for feedback information, then the groups of data communication channels should include the characteristic of providing feedback information using a bandwidth between 10 Mb/s and 100 Mb/s.

With regard to the use restrictions for medium types of physical interfaces, the application requirements may indicate that, for example, a fiber optic medium should be used to send data between the endpoints, and that a wireless medium should not be used to send the data. The use restrictions may apply to individual physical interfaces or to the bondable virtual interface.

With respect to the data stream type category, the data stream type category is one of a non-time critical data stream, a near-time critical data stream, and a time critical data stream. An example of a data stream in the time critical (TC) category is an interactive data stream such as a video conference stream. An example of a data stream in the near-time critical (nearTC) category is a stream that carries a High Definition (HD) video content. An example of a data stream in the non-time critical (nonTC) category is a file transfer data stream. The data stream type category is taken into consideration when determining which groups of data communication channels to include in the first list. In other words, groups of data communication channels which substantially accommodate the data stream type category are included in the first list. For example, if the data stream is specified as a time critical data stream, then the groups of data communication channels included in the first list may include data communication channels having high data capacity throughputs, so that the time critical data stream is sent quickly.

In one aspect of this example embodiment, the groups of data communication channels included in the first list are provided in order of preference according to the first endpoint. In this regard, the data stream type category can be used to determine the order of preference of the groups of data communication channels according to the first endpoint. Thus, in a case that a number of suitable combinations exist between the groups of data communication channels included in the first list and the groups of data communication channels included in the second list, the stream type category can be used to determine which groups of data communication channels to select. For example, if two groups of data communication channels on each endpoint are suitable combinations, and a time critical data stream is specified, then the groups having a larger data capacity throughput would be selected.

In a case that a feedback mechanism is to be included to provide feedback information, the selected group of data communication channels at the first endpoint and the corresponding group of data communication channels at the second endpoint, each include one or more data communication channels for providing the feedback information from the receiving endpoint to the sending endpoint. The one or more data communication channels provided for the feedback information may be preexisting data communication channels on which data is already sent, or separate data communication channels on which data is not already being sent.

In step 602, a determination is made as to whether the second endpoint is able to select one of the groups of data communication channels included in the first list that corresponds with a group of data communication channels from the second list. If the second endpoint is able to select one of the groups of data communication channels included in the first list, the process proceeds to step 603. If the second endpoint is not able to select one of the groups of data communication channels included in the first list, the process proceeds to step 609.

In step 603, a selection is made by the second endpoint of one of the groups of data communication channels included in the first list. The second endpoint selects the one group of data communication channels by comparing the groups in the first list with groups in a second list. The second list includes one or more groups of data communication channels at the second endpoint on which to send or receive data, based at least partially on characteristics of the data communication channels.

More specifically, the second endpoint compares the groups of data communication channels included in the first list with the groups of data communication channels included in the second list in order to match groups of data communication channels having substantially similar characteristics. The second endpoint then selects a group of data communication channels from the first list and a corresponding group of data communication channels from the second list, which have substantially similar characteristics. In a case that there is more than one pairing of data communication channels having substantially similar characteristics, the second endpoint selects the group of data communication channels included in the first list that is first in order of preference of the groups of data communication channels provided by the first endpoint.

In step 604, the selected group of data communication channels included in the first list is sent from the second endpoint to the first endpoint. One or more communication channels are then established at the first endpoint (step 605). In addition, one or more communication channels are established at the second endpoint (step 606). The communication channels are established in accordance with the selected group of data communication channels included in the first list and a corresponding group of data communication channels included in the second list. For example, if the second endpoint selected a group 2 of the groups of data communication channels included in the first list because the group 2 matched well with a group 1 of the groups of data communication channels included in the second list, then communication channels are established at the first endpoint which correspond with group 2, and communication channels are established at the second endpoint which correspond with group 1.

In step 607, data is sent over the one or more communication channels established at the sending endpoint 101. The data is then received over the one or more communication channels established at the receiving endpoint 102 (step 608).

By virtue of the foregoing example embodiment, it is ordinarily possible to intelligently pair communication channels on the sending endpoint with communication channels on the receiving endpoint, so as to efficiently and reliably stream data between the endpoints. More specifically, since a selection is made by a second one of the sending and receiving endpoints of one of groups of data communication channels included in a first list of network channel configurations provided by a first one of the sending and receiving endpoints, it is possible to ensure that data communication channels at the sending endpoint are paired with similar data communication channels at the receiving endpoint. As a result, any negative effects such as a reduction in data throughput, due to, for example, pairing of communication channels at the sending endpoint with incompatible communication channels at the receiving endpoint, can be substantially minimized.

In one case, in step 609, the second endpoint sends the second list to the first endpoint. The first endpoint then selects a group of data communication channels included in the second list by comparing the groups of the second list with the groups of the first list (step 610). The selected group of data communication channels is then sent to the second endpoint (step 611). One or more communication channels are then established at the first endpoint (step 605). In addition, one or more communication channels are established at the second endpoint (step 606). The communication channels are established in accordance with the selected group of data communication channels included in the second list and a corresponding group of data communication channels included in the first list.

In another case, in step 609, the second endpoint sends a third list including one group of data communication channels to the first endpoint. Then, in step 610, the first endpoint selects a group of data communication channels from the first list that conforms to the one group of data communication channels included in the third list. The selected group of data communication channels is then sent to the second endpoint (step 611). One or more communication channels are then established at the first endpoint (step 605). In addition, one or more communication channels are established at the second endpoint (step 606). The communication channels are established in accordance with the selected group of data communication channels included in the first list and a corresponding group of data communication channels included in the third list.

Generally, if the sending endpoint 101 receives the first list from the receiving endpoint 102, and the sending endpoint 101 cannot conform to any of the groups of data communication channels included in the first list, then the sending endpoint 101 will send a group of data communication channels that the receiving endpoint 102 should conform with. Thus, the receiving endpoint 102 should default to conforming, since the sending endpoint 101 which is normally the server dictates what endpoint to use.

In step 607, data is sent over the one or more communication channels established at the sending endpoint 101. The data is then received over the one or more communication channels established at the receiving endpoint 102 (step 608).

This disclosure has provided a detailed description with respect to particular illustrative embodiments. It is understood that the scope of the appended claims is not limited to the above-described embodiments and that various changes and modifications may be made by those skilled in the relevant art without departing from the scope of the claims.

What is claimed is:

1. A method for initializing a sending of a single data stream from a sending endpoint to a receiving endpoint, wherein both of the sending endpoint and the receiving endpoint each have multiple physical interfaces connecting the sending endpoint and the receiving endpoint to one or more networks, respectively, and the data stream is split and sent over the multiple physical interfaces, the method comprising:
sending by a first one of the sending endpoint and the receiving endpoint a first list to a second one of the sending endpoint and the receiving endpoint, wherein the first list includes one or more groups of data communication channels at the first endpoint on which to send or receive data, based at least partially on characteristics of the data communication channels;
selecting by the second endpoint one of the groups of data communication channels included in the first list, wherein the second endpoint selects the one group of data communication channels by comparing the groups in the first list with groups in a second list, wherein the second list includes one or more groups of data communication channels at the second endpoint on which to send or receive data, based at least partially on characteristics of the data communication channels;
sending from the second endpoint to the first endpoint the selected group of data communication channels included in the first list;
establishing one or more communication channels at the first endpoint and one or more communication channels at the second endpoint, respectively, in accordance with the selected group of data communication channels included in the first list and a corresponding group of data communication channels included in the second list; and
sending the data over the one or more communication channels established at the sending endpoint, and receiving the data over the one or more communication channels established at the receiving endpoint.

2. A method according to claim 1, wherein the first endpoint is the sending endpoint and the second endpoint is the receiving endpoint.

3. A method according to claim 1, wherein the first endpoint is the receiving endpoint and the second endpoint is the sending endpoint.

4. A method according to claim 1, wherein the characteristics of the data communication channels include a medium type of the physical interface associated with the data communication channel, a bandwidth of the physical interface associated with the data communication channel, a medium flow control of the physical interface associated with the data communication channel, and a data capacity throughput of the physical interface associated with the data communication channel.

5. A method according to claim 4, wherein a data communication channel associated with a physical interface at the first endpoint having one medium type is paired with a data communication channel associated with a physical interface at the second endpoint having the same medium type.

6. A method according to claim 4, wherein a data communication channel associated with a physical interface at the first endpoint having one bandwidth is paired with a data communication channel associated with a physical interface at the second endpoint having substantially the same bandwidth.

7. A method according to claim 4, wherein a data communication channel associated with a physical interface at the first endpoint having one medium flow control is paired with a data communication channel associated with a physical interface at the second endpoint having the same medium flow control.

8. A method according to claim 4, wherein a data communication channel associated with a physical interface at the first endpoint having one data capacity throughput is paired with a data communication channel associated with a physical interface at the second endpoint having substantially the same data capacity throughput.

9. A method according to claim 1, wherein in a case that the second endpoint is not able to select a group of data communication channels from the first list that corresponds with a group of data communication channels from the second list, the second endpoint sends the second list to the first endpoint, the first endpoint selects a group of data communication channels by comparing the groups of the second list with the groups of the first list, and sends the selected group of data communication channels to the second endpoint.

10. A method according to claim 1, wherein in a case that the second endpoint is not able to select a group of data communication channels from the first list that corresponds with a group of data communication channels from the second list, the second endpoint sends a third list including one group of data communication channels to the first endpoint, and the first endpoint selects a group of data communication channels from the first list that conforms to the one group of data communication channels included in the third list.

11. A method according to claim 1, wherein in a case that a feedback mechanism is to be included to provide feedback information, the selected group of data communication channels at the first endpoint and the corresponding group of data communication channels at the second endpoint, each include one or more communication channels for providing the feedback information from the receiving endpoint to the sending endpoint.

12. A method according to claim 1, wherein the groups of data communication channels are registered as bondable virtual interfaces.

13. A method according to claim 12, wherein the bondable virtual interfaces include application requirements, which include at least one of a preferred minimum and maximum bandwidth for the streaming data, a preferred minimum and maximum bandwidth for feedback information, a data stream type category, use restrictions for medium types of physical interfaces, and a preferred number of communication channels to be used in sending data.

14. A method according to claim 13, wherein the application requirements are used to determine the characteristics of data communication channels.

15. A method according to claim 13, wherein the data stream type category is one of a non-time critical data stream, a near-time critical data stream, and a time critical data stream.

16. A method according to claim 15, wherein the data stream type category is taken into consideration when determining which groups of data communication channels to include in the first list.

17. A method according to claim 1, wherein the groups of data communication channels included in the first list are provided in order of preference according to the first endpoint.

18. An endpoint comprising:
an interface to multiple physical interfaces connecting a sending endpoint and a receiving endpoint to one or more networks;
a computer-readable memory constructed to store computer-executable process steps; and
a processor constructed to execute the computer-executable process steps stored in the memory,
wherein the process steps in the memory cause the processor to initialize a sending of a single data stream from the sending endpoint to the receiving endpoint, and the data stream is split into a series of data packets and sent over the multiple physical interfaces, and wherein the process steps stored in the memory include computer-executable steps to:
send by a first one of the sending endpoint and the receiving endpoint a first list to a second one of the sending endpoint and the receiving endpoint, wherein the first list includes one or more groups of data communication channels at the first endpoint on which to send or receive data, based at least partially on characteristics of the data communication channels;
select by the second endpoint one of the groups of data communication channels included in the first list, wherein the second endpoint selects the one group of data communication channels by comparing the groups in the first list with groups in a second list, wherein the second list includes one or more groups of data communication channels at the second endpoint on which to send or receive data, based at least partially on characteristics of the data communication channels;
send from the second endpoint to the first endpoint the selected group of data communication channels included in the first list;
establish one or more communication channels at the first endpoint and one or more communication channels at the second endpoint, respectively, in accordance with the selected group of data communication channels included in the first list and a corresponding group of data communication channels included in the second list; and
send the data over the one or more communication channels at the sending endpoint, and receive the data over the one or more communication channels at the receiving endpoint.

19. An endpoint according to claim 18, wherein the first endpoint is the sending endpoint and the second endpoint is the receiving endpoint.

20. An endpoint according to claim 18, wherein the first endpoint is the receiving endpoint and the second endpoint is the sending endpoint.

21. An endpoint according to claim 18, wherein the characteristics of the data communication channels include a medium type of the physical interface associated with the data communication channel, a bandwidth of the physical interface associated with the data communication channel, a medium flow control of the physical interface associated with the data communication channel, and a data capacity throughput of the physical interface associated with the data communication channel.

22. An endpoint according to claim 21, wherein a data communication channel associated with a physical interface at the first endpoint having one medium type is paired with a data communication channel associated with a physical interface at the second endpoint having the same medium type.

23. An endpoint according to claim 21, wherein a data communication channel associated with a physical interface at the first endpoint having one bandwidth is paired with a data communication channel associated with a physical interface at the second endpoint having substantially the same bandwidth.

24. An endpoint according to claim 21, wherein a data communication channel associated with a physical interface at the first endpoint having one medium flow control is paired with a data communication channel associated with a physical interface at the second endpoint having the same medium flow control.

25. An endpoint according to claim 21, wherein a data communication channel associated with a physical interface at the first endpoint having one data capacity throughput is paired with a data communication channel associated with a physical interface at the second endpoint having substantially the same data capacity throughput.

26. An endpoint according to claim 18, wherein in a case that the second endpoint is not able to select a group of data communication channels from the first list that corresponds with a group of data communication channels from the second list, the second endpoint sends the second list to the first endpoint, the first endpoint selects a group of data communication channels by comparing the groups of the second list with the groups of the first list, and sends the selected group of data communication channels to the second endpoint.

27. An endpoint according to claim 18, wherein in a case that the second endpoint is not able to select a group of data communication channels from the first list that corresponds with a group of data communication channels from the second list, the second endpoint sends a third list including one group of data communication channels, and the first endpoint selects a group of data communication channels from the first list that conforms to the one group of data communication channels included in the third list.

28. An endpoint according to claim 18, wherein in a case that a feedback mechanism is to be included to provide feedback information, the selected group of data communication channels at the first endpoint and the corresponding group of data communication channels at the second endpoint, each include one or more communication channels for providing the feedback information from the receiving endpoint to the sending endpoint.

29. An endpoint according to claim 18, wherein the groups of data communication channels are registered as bondable virtual interfaces.

30. An endpoint according to claim 29, wherein the bondable virtual interfaces include application requirements, which include at least one of a preferred minimum and maximum bandwidth for the streaming data, a preferred minimum and maximum bandwidth for feedback information, a data stream type category, use restrictions for medium types of physical interfaces, and a preferred number of communication channels to be used in sending data.

31. An endpoint according to claim 30, wherein the application requirements are used to determine the characteristics of data communication channels.

32. An endpoint according to claim 30, wherein the data stream type category is one of a non-time critical data stream, a near-time critical data stream, and a time critical data stream.

33. An endpoint according to claim 32, wherein the data stream type category is taken into consideration when determining which groups of data communication channels to include in the first list.

34. An endpoint according to claim 18, wherein the groups of data communication channels included in the first list are provided in order of preference according to the first endpoint.

35. A computer-readable memory medium on which is stored computer-executable process steps for causing a processor to initialize a sending of a single data stream from a sending endpoint to a receiving endpoint, wherein both of the sending endpoint and the receiving endpoint each have multiple physical interfaces connecting the sending endpoint and the receiving endpoint to one or more networks, respectively, and the data stream is split into a series of data packets and sent over the multiple physical interfaces, the process steps comprising:
sending by a first one of the sending endpoint and the receiving endpoint a first list to a second one of the sending endpoint and the receiving endpoint, wherein the first list includes one or more groups of data communication channels at the first endpoint on which to send or receive data, based at least partially on characteristics of the data communication channels;
selecting by the second endpoint one of the groups of data communication channels included in the first list, wherein the second endpoint selects the one group of data communication channels by comparing the groups in the first list with groups in a second list, wherein the second list includes one or more groups of data communication channels at the second endpoint on which to send or receive data, based at least partially on characteristics of the data communication channels;
sending from the second endpoint to the first endpoint the selected group of data communication channels included in the first list;
establishing one or more communication channels at the first endpoint and one or more communication channels at the second endpoint, respectively, in accordance with the selected group of data communication channels included in the first list and a corresponding group of data communication channels included in the second list; and
sending the data over the one or more communication channels established at the sending endpoint, and receiving the data over the one or more communication channels established at the receiving endpoint.
